(19) United States
(12) Patent Application Publication
(10) Pub. No.: US 2005/0223335 A1
(43) Pub. Date: Oct. 6, 2005

(54) Button processing method and data processing apparatus

(76) Inventor: Tetsuya Ichikawa, Iwaki-city (JP)

Correspondence Address: BRINKS HOFER GILSON & LIONE, P.O. BOX 10395, CHICAGO, IL, 60610, US

(21) Appl. No.: 11/086,257

(22) Filed: Mar. 21, 2005

(30) Foreign Application Priority Data
Mar. 31, 2004 (JP) 2004-104030

(51) Int. Cl. G06F 3/00

(52) U.S. Cl. 715/801; 715/798; 715/800; 715/840

(57) ABSTRACT

A button processing method and a data processing apparatus that improve the operability of buttons when a display device with a display screen of small size is employed. In cases where an output image includes a button, when a display image is displayed on a display device with a small display device size, e.g., 6.5 inches, the size of the button in an image space is enlarged n times at a button enlargement ratio determined in accordance with the display device size. In contrast, when a display image is displayed on the display device with a larger display device size, e.g., 8 inches, the size of the button in an image space is enlarged, e.g., n/1.23 times at a button enlargement ratio determined in accordance with the display device size. That is, the smaller the size of the display screen of the display device, the larger the enlargement ratio of the size of the button in the image space, so that the button is displayed in predetermined size on the display device regardless of the display screen size of the display device.

### BACKGROUND OF THE INVENTION

1. Field of the Invention

The present invention relates to techniques for improving the operability of buttons in user interfaces for receiving an operation command for the button displayed on a display device via an input device.

2. Description of the Related Art

In DVD-Video discs defined by the DVD-Video specification, providers can incorporate within recorded data a definition for displaying buttons, receiving a user's selection/determination of the button, and performing reproduction in accordance with the button selected. Such a button is defined as an area on a subpicture, which is basically a still image, in the recorded data of the DVD-Video disc.

To improve the operability of buttons for receiving the user's operations, a well known technique enlarges a button to a prescribed size and displays it, when a point designated by a pointing device such as a mouse approaches the button in a predetermined direction, or enlarges an operation receipt area for receiving a button operation to a prescribed size sufficient to cover an area around the button, as disclosed in JP-A-2002-297283 (hereinafter referred to as “patent document 1”).

Further, to improve the operability of a touch panel for display objects, such as buttons, which serve as elements to be displayed on a display device, a technique is also well known which, in cases where a resolution of the touch panel is lower than that of the display screen, enlarges and displays a plurality of display objects so that they may be distributed to and disposed at different areas on the display screen corresponding respectively to different coordinates on the touch panel when the plurality of display objects with lower resolution thereof than that of the touch panel are located within an area of the display screen corresponding to the coordinate entered from the touch panel, as disclosed in JP-A-H06-19613 (hereinafter referred to as “patent document 2”).

As described above, in the DVD-Video disc, the button for receiving the user's operation is defined as an area on the subpicture which is a still image. Display devices with large and small display screen sizes have the respective buttons displayed thereon with the same ratio of the button size to the display screen size. Thus, in a system using a display device with a small display screen, for example, in a hand-held or vehicle-mounted DVD video reproduction apparatus, the size of the displayed button becomes too small to obtain good visibility and operability.

When the buttons are rendered extremely small depending on the display screen size and come close to each other, it is difficult to specify which one is a button being approached by a point designated by the pointing device, so that the technique as disclosed in the above-mentioned patent document 1 cannot be applied to the system. In this technique, since the button and button operation receipt area are enlarged to the predetermined size, the button and button operation receipt area in a display device with a large display screen size are expanded to a size larger than necessary, while the button and button operation area in a device with a small screen size cannot be enlarged to a size sufficient to ensure good operability.

On the other hand, even if the technique disclosed in the patent document 2 is applied, when the resolution of the display screen is approximately the same as that of the touch panel, the button is displayed in extremely small size on a display device with a small display screen, thereby failing to improve the operability of the buttons.

### SUMMARY OF THE INVENTION

It is, therefore, an object of the present invention to improve the operability of a button in a user interface using a position input device and a display device, which button might be displayed in a small size as it is in the prior art because of its small size relative to a predefined display screen.

To solve the foregoing problems encountered with the known art, according to one aspect of the invention, there is provided a button processing method for displaying a button on a display device in accordance with a button area definition for specifying the size and arrangement of the button in an image space, and receiving an operation corresponding to the displayed button via an input device. The method comprises the steps of, when the size of a display screen of the display device is smaller than a predetermined screen size, setting an enlargement ratio of the button in such a manner that the smaller the display screen size, the larger the ratio, and enlarging the button whose display size on the display device is smaller than a predetermined size at the button enlargement ratio to display the enlarged button on the display device, wherein the display size of the button is defined by the display screen size and the size of the button in the image space specified by at least the button area definition.

In such a button processing method, the button is enlarged in the image space at the enlargement ratio set in such a manner that the smaller the display screen size of the display device, the larger the ratio. The actual size of the enlarged button on the display screen is proportional to the display screen size of the display device. Thus, when using a display device with a relatively large display screen size, the button can be enlarged to and displayed in a proper display size so as to facilitate its operation on the display device, regardless of the display screen size of the display device, while being prevented from being enlarged and displayed to an excessive degree.

To achieve the above-mentioned object, according to another aspect of the invention, there is provided a button processing method for displaying a button on a display device in accordance with a button area definition for specifying the size and arrangement of the button in an image space, and receiving an operation corresponding to the displayed button via an input device. The method comprises the step of, when a size of a display screen of the display device is smaller than a predetermined screen size, setting a receipt area of the button operation centering on the button in such a manner that the smaller the display screen size of the display device, the larger a size of the button-operation receipt area in the image space, for the button whose display size on the display device is smaller than a predetermined size. The display size of the button on the display device is defined by the display screen size and the size of the button in the image space specified by at least the button area definition. The method further comprises the step of receiving the operation of the button whose button-operation receipt area has been set, in accordance with an operation positioning a point via the input device within an area on the display screen corresponding to the button-operation receipt area.

In such a button processing method, the button-operation receipt area for receiving the button operation is set in such a manner that the smaller the display screen size of the display device, the larger the size of the receipt area in the image space. The size of the button-operation receipt area on the display screen is proportional to the display screen size of the display device. Thus, when using a display device with a relatively large display screen size, the button-operation receipt area can be set in a proper size so as to facilitate its operation on the display device, regardless of the display screen size of the display device, while being prevented from being enlarged and set to an excessively large size.

To achieve the above-mentioned object, according to still another aspect of the invention, there is provided a button processing method for displaying a button and receiving an operation corresponding to the displayed button via an input device. The method comprises the steps of setting a receipt area of a button enlargement operation around the button, for at least a button whose display size on a display device is smaller than a predetermined size, and enlarging the button whose button-enlargement-operation receipt area has been set to display the enlarged button on the displayed device in accordance with an operation positioning a point within the button-enlargement-operation receipt area via the input device.

In such a button processing method, the button is enlarged and displayed in accordance with an operation positioning the point within the button-enlargement-operation receipt area provided around the button. Thus, when a user accidentally manipulates or operates not the button, but a surrounding part thereof inaccurately because of the small size of the button, the button is automatically enlarged. This enables the user to easily operate the button. When the visibility of the button is not sufficient because of its small display size, the use of the above-mentioned function enlarges and displays the button by operating the surrounding part of the button without the user's directly manipulating the button, thereby permitting the user to confirm the contents of the button operation. Additionally, after such confirmation, the button can be operated in a state in which it is enlarged and thus becomes more accessible to the users.

To achieve the above-mentioned object, according to a further aspect of the invention, there is provided a button processing method for displaying a button and receiving an operation corresponding to the displayed button via an input device. The method comprises the step of setting a receipt area of the button operation which includes the button and the surrounding area thereof, for at least a button whose display size on a display device is smaller than a predetermined size. In the case where a positioning operation of a point is performed within the button-operation receipt area via the input device, when the single button-operation receipt area including the point exists, the method further comprises the step of receiving the operation of the button whose button-operation receipt area has been set. On the other hand, in the case where a positioning operation of a point is performed within said button-operation receipt area via the input device, when a plurality of button-operation receipt areas including the point exist, the method further comprises the step of receiving the operation of the button having the shortest distance to the point among the plurality of buttons whose button-operation receipt areas have been set.

In such a button processing method, the button-operation receipt area for receiving the operation of the button is enlarged so as to include the button and its surroundings. In a case where the button-operation receipt areas overlap each other, when a point is designated within the overlapped areas, only the operation of the button located closest to the point positioned by the user is received. Therefore, even in such cases, the user can easily perform the operation of the desired button.

According to a still further aspect of the invention, there is provided a button processing method for displaying a button and receiving an operation corresponding to the displayed button via an input device. The method comprises the steps of setting a receipt area of the button operation which includes the button and the surrounding area thereof, for at least a button whose display size on a display device is smaller than a predetermined size. In the case where a positioning operation of a point is performed within the button-operation receipt area via the input device, when the single button-operation receipt area including the point exists, the method further comprises the step of receiving the operation of the button whose button-operation receipt area has been set. In the case where a positioning operation of a point is performed within the button-operation receipt area via the input device, when a plurality of button-operation receipt areas including the point exist, the method further comprises the step of enlarging the plurality of buttons whose button-operation receipt areas have been set to display the enlarged buttons on the display device.

In such a button processing method, the button-operation receipt area for receiving the operation of the button is enlarged so as to include the button and its surroundings. In a case where the button-operation receipt areas overlap each other, when a point is designated within the overlapped areas, the plurality of buttons within the button-operation receipt areas where the point is positioned are enlarged and displayed. Therefore, even in such cases, the user can surely perform the operation of the desired button with ease using the enlarged button.

As mentioned above, the invention can improve the operability of a button in the user interface using the position input device and the display device, which button otherwise might be displayed in an excessively small size because of its small size relative to a predefined display screen.

### BRIEF DESCRIPTION OF THE DRAWINGS

FIG. 1 is a block diagram showing a configuration of a DVD video reproduction apparatus according to a first preferred embodiment of the invention;

FIG. 2 is a schematic diagram of button display in the DVD video reproduction apparatus;

FIG. 3 is a flowchart of button control processing according to the first embodiment;

FIG. 4 shows an example of button control according to the first embodiment;

FIG. 5 is a flowchart of button control processing according to a second preferred embodiment of the invention;

FIG. 6 shows an example of button control according to the second embodiment;

FIG. 7 is a flowchart of button control processing according to a third embodiment;

FIG. 8 shows an example of button control according to the third embodiment;

FIG. 9 is a flowchart of button control processing according to a fourth preferred embodiment; and

FIG. 10 shows an example of button control according to the fourth embodiment.

### DESCRIPTION OF THE PREFERRED EMBODIMENTS

Some preferred embodiments according to the present invention will be described hereinafter with reference to the accompanying drawings by taking an application of a DVD video reproduction apparatus as an example.

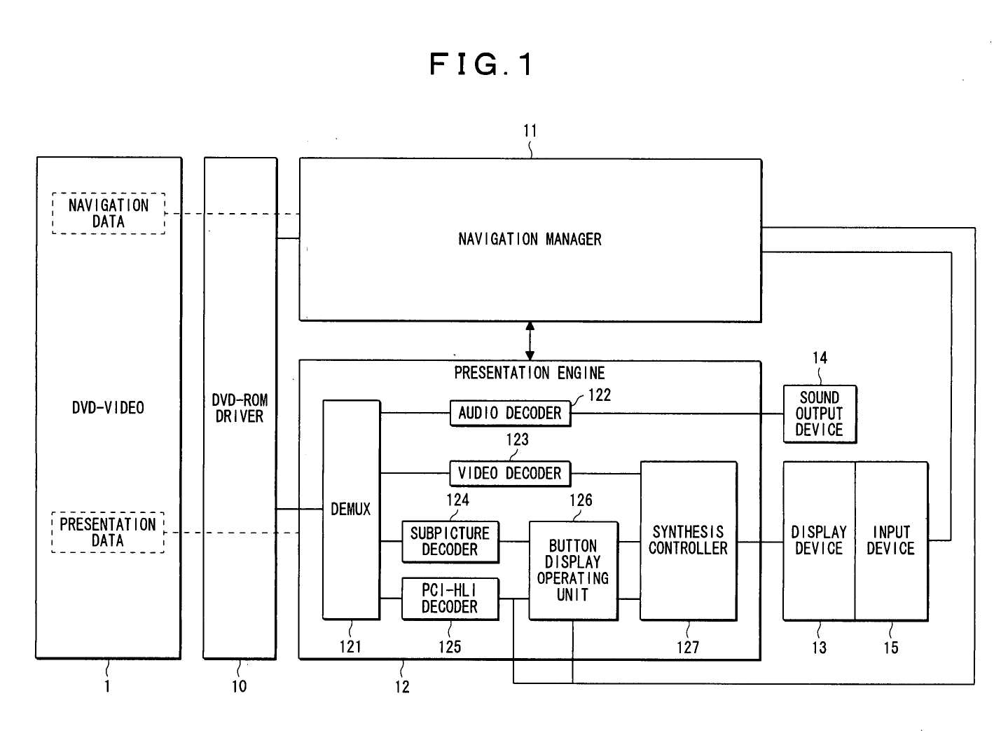

First, a first preferred embodiment of the invention will be described below. FIG. 1 shows a configuration of a DVD video reproduction apparatus according to the first embodiment.

As shown in the figure, the DVD video reproduction apparatus includes a DVD-ROM driver 10 for performing a read access to a DVD-Video disc 1, a navigation manager 11, a presentation engine 12 for reproducing and outputting video, a display device 13, a sound output device 14, such as a speaker, for outputting sound, and an input device 15, such as a touch panel, disposed on a display screen of the display device 13.

In the DVD-Video disc 1, application data in compliance with a DVD-Video specification is stored. The application data is classified broadly into and is composed of presentation data including a presentation entity, such as sound data, moving image data, subpicture data, and highlight information, and navigation data for controlling the execution of presentation.

In the presentation engine 12, a demultiplexer function unit 121 reads the presentation data from the DVD-Video disc 1 and extracts the sound data, the moving image data, the subpicture date, and the highlight information about the button from the presentation data. An audio decoder 122 decodes the extracted sound data to supply it to the sound output device 14. A video decoder 123 decodes the extracted moving image data. A subpicture decoder 124 decodes the subpicture data. A PCI-HLI decoder 125 decodes the highlight information. A button display operating unit 126 creates an image including the button defined by the subpicture and the highlight information to supply it as an output picture image. Under control of the navigation engine, the button is enlarged, and the arrangement of buttons is altered.

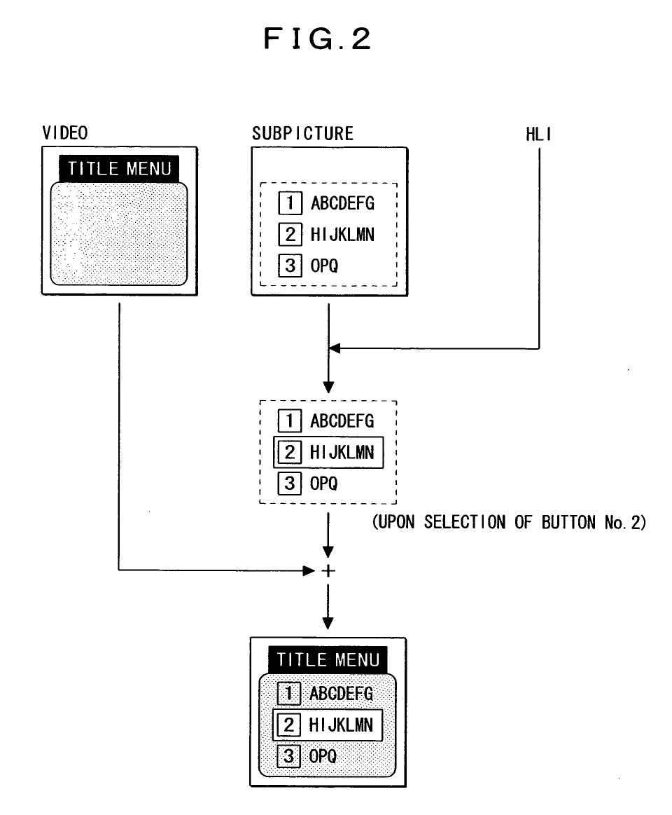

Now, how to define the button by the subpicture and the highlight information will be described with reference to FIG. 2.

A screen on which the button is displayed is created by superimposing a subpicture operated in accordance with the highlight information on a moving image. The subpicture is basically a still image. A rectangular area on the subpicture described by the highlight information HLI is an area for the button. The button selected or determined by the user is expressed by changing a display color of the button area on the subpicture or a composite rate of the subpicture to the moving image in accordance with the highlight information. In the example shown, upon the user's selection of the button No. 2, the display color of an area for the button No. 2 of the subpicture is changed depending on the highlight information. The highlight information HLI includes a button command BTN_CMD defining a procedure to be executed when each button is operated or manipulated by the user.

Referring back to FIG. 1, a synthesis controller 127 synthesizes the decoded moving image and an output picture image edited by the button display operating unit 126 to provide as an output the synthesized image. Then, the controller carries out pixel number conversion processing of this image for matching an image size thereof with a display screen size of the display device to supply the converted image to the display device 13 as a display image. For example, the pixel number conversion processing involves converting an image of 720×240 pixels generated based on the presentation data into a display image of the same size as the display screen size of the display device 13, e.g. 480×234 pixels.

The navigation manager 11 determines sequences of the presentation in accordance with the navigation data read therein by the DVD-ROM driver 10 and the user's operation received from the input device 15, and controls the operation of reproducing output provided by the presentation engine 12 in each determined sequence.

Note that the above-mentioned DVD video reproduction apparatus may be a general-purpose computer which includes the DVD-ROM driver 10, the display device 13, the sound output device 14, and the input device 15 as peripheral devices. In this case, the above-mentioned navigation engine, the presentation engine, or a part thereof may be implemented as a process on the computer by executing a program with the computer.

In the DVD video reproduction apparatus with such an arrangement, the navigation engine executes button control processing when reproducing the DVD-Video disc 1.

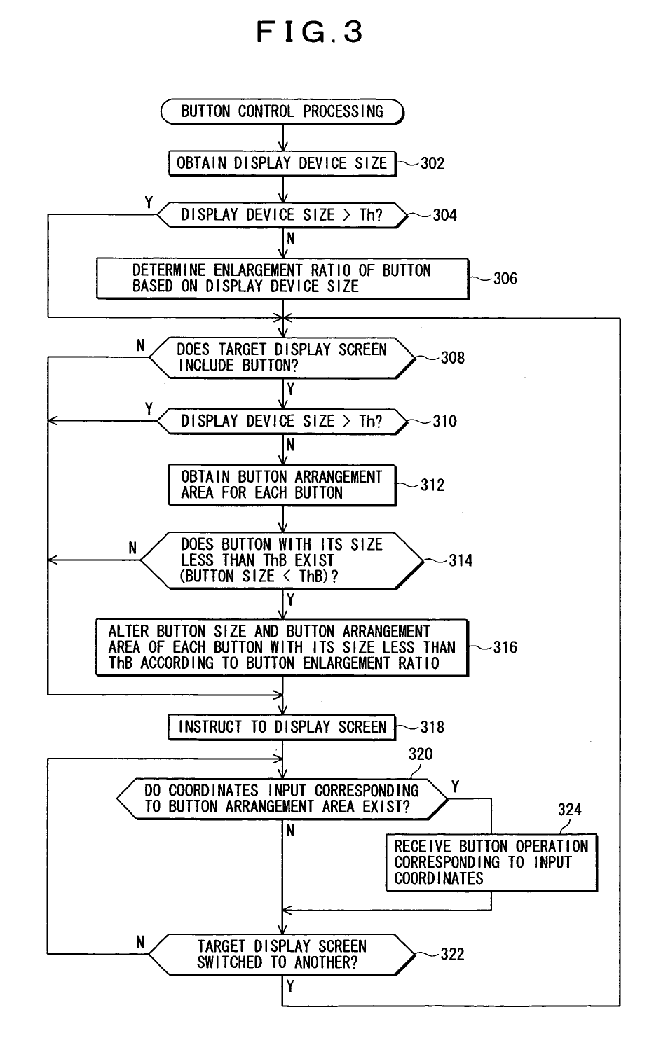

FIG. 3 illustrates the steps of the button control processing.

In the processing shown in FIG. 3, first, the size of the display screen of the display device 13 is determined as a display device size (step 302). The screen size may be obtained by receiving a user's setting operation of the display screen size. If possible, the screen size may be obtained by receiving an identification of the display screen size from the display device 13.

Then, it is determined whether the obtained display screen size is equal to or smaller than a preset threshold value Th (for example, 11 inches) or not (step 304). If it is not, the operation proceeds to step 308. If it is equal to or smaller, an enlargement ratio of the button is determined in accordance with the display device size (step 306), and then the operation proceeds to step 308. The button enlargement ratio is set in such a manner that the smaller the display device size, the larger the ratio.

At step 308, it is determined whether or not a target display screen to be displayed has a screen image including the button, based on the navigation data and the highlight information decoded by the PCI-HLI decoder 125. Additionally, it is determined whether the display device size is larger than the above-mentioned threshold value Th or not (step 310). If the target display screen does not include the button, or if the display device size exceeds the threshold value Th, the operation proceeds to step 318. On the other hand, if the target display screen includes the button and the display device size is equal to or smaller than the threshold value Th, a button arrangement area for each button included in the target display screen is obtained based on the highlight information decoded by the PCI-HLI decoder 125 (step 312). The button arrangement area indicates the size (pixel numbers) and arrangement position of each button on the displayed output image before the pixel number conversion.

It is determined whether or not there is a button whose size (pixel numbers) on the output image before the pixel number conversion is smaller than a predetermined threshold value ThB (step 314). If not, the operation proceeds to step 318. Note that the threshold value ThB of the button size may be fixed, but also may be determined according to the display device size obtained at step 302. For example, the threshold value THBV is set as a vertical pixel number determined when the display device size×vertical pixel number/vertical pixel number of the output image is 1 cm. Likewise, the threshold value THBH is set as a horizontal pixel number determined when the display device size×horizontal pixel number/horizontal pixel number of the output image is 1 cm. If the vertical size of the button on the output image before the pixel number conversion is smaller than the value ThBV, or if the horizontal button size on the output image before the pixel number conversion is smaller than the value THBH, it may be determined that the button size on the output image before the pixel number conversion is smaller than the value ThB.

If a button whose size on the output image before the pixel number conversion is smaller than the threshold value ThB exists, the button is regarded as a target. The button enlargement ratio determined at step 306 is provided to the button display operating unit 126. A new arrangement position of each target button on the output image before the conversion is calculated to be provided to the button display operating unit 126 (step 316). The new arrangement position of the target button is determined to be the position where the enlarged target button is not overlapping another when each target button is enlarged at the button enlargement ratio on the output image before the conversion.

At step 318, the presentation engine 12 provides display outputs to the display device 13 with the target display screen. At this time, in receiving the enlargement ratio or new arrangement position of the target button from the button control processing, the button display operating unit 126 of the presentation engine 12 alters the size and arrangement area of the target button on the output image before the pixel number conversion. That is, an image in an area on the subpicture corresponding to a rectangular area specified by the highlight information about the target button is extracted, and then is enlarged at the identified enlargement ratio to be rearranged at the identified arrangement position on the subpicture. Then, the highlight information about the target button is modified in the following manner. That is, the rectangular area specified by the highlight information before the conversion has its size enlarged at the identified enlargement ratio, and the position of the rectangular area specified by the highlight information is aligned with the identified arrangement position. Thereafter, an output picture image is created including each button in the above-mentioned manner in accordance with the subpicture and the highlight information.

It should be noted that if the button display operating unit 126 is not given the enlargement ratio and the new arrangement position of the target button by the button control processing, the operating unit does not modify the highlight information and generates the output picture image including each button as it exists in accordance with the subpicture and highlight information.

After such display of the target display screen, the presence of coordinates input within the button arrangement area from the input device 15 is checked (step 320). Then, switching of the target display screen to another is checked (step 322).

If the input of coordinates occurs within the button arrangement area (step 320), a selection or determination operation of the button corresponding to the button arrangement area is received, a display format indicative of a button selection state is altered, or a button command defined for the button is executed (step 324), and then the operation returns to the checking step as denoted at step 320 and/or step 322. In detecting the occurrence of the coordinate input within the button arrangement area, the rectangular area specified by the highlight information about each button is regarded as the button arrangement area. At this time, the highlight information modified as described above is used for the target button. The coordinates entered from the input device 15 are converted into coordinates on the output image before the pixel number conversion. This coordinate conversion depends on a relationship of the coordinates between the display image and an output image specified according to the pixel number conversion processing performed by the synthesis controller 127, and on a relationship between the coordinates detected by the input device 15 and the coordinates on the display image corresponding to the detected coordinates.

If the target display screen is switched to another screen, the operation returns to step 308. It should be noted that a timeout occurs after the button command is executed at step 324, or after the button operation is neglected and not performed by the user, whereby the target display screen automatically changes to another.

As explained above, the button control processing is performed by the navigation engine.

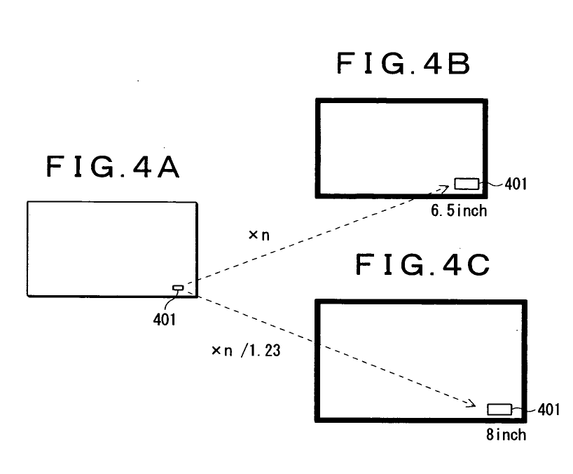

According to this button control processing, for example, in a case where the output image before the pixel number conversion includes the button 401 as shown in FIG. 4A, when a display image is displayed on the display device 13 with its display device size of 6.5 inches as shown in FIG. 4B, the button 401 is enlarged n times in the output image at the button enlargement ratio, which is determined in accordance with the display device size. On the other hand, when the display image is displayed on the display device 13 with its display device size of 8 inches as shown in FIG. 4C, the button 401 is enlarged n/1.23 times in the output image at the button enlargement ratio, which is determined in accordance with the display device size. Then, the actual display size of the output image on the display device 13 is proportional to the display screen size of the display device.

That is, the smaller the display screen size of the display device 13, the larger the enlargement ratio of the button 401, and the actual size of the button 401 on the display screen is proportional to the size of the display screen of the display device 13. Accordingly, the buttons which are considered to have the same size in the presentation data have the same size on the display screens with respect to each other, i.e. the same size to the user. Therefore, for a display device 13 with a relatively large display screen, the button 401 can be enlarged to and displayed in a proper size so as to facilitate its operation, regardless of the display screen size of the display device 13, while being preventing from being enlarged to and displayed in an excessively large size.

The first embodiment of the invention has been explained in the above description. Now, a second preferred embodiment of the invention will be described below.

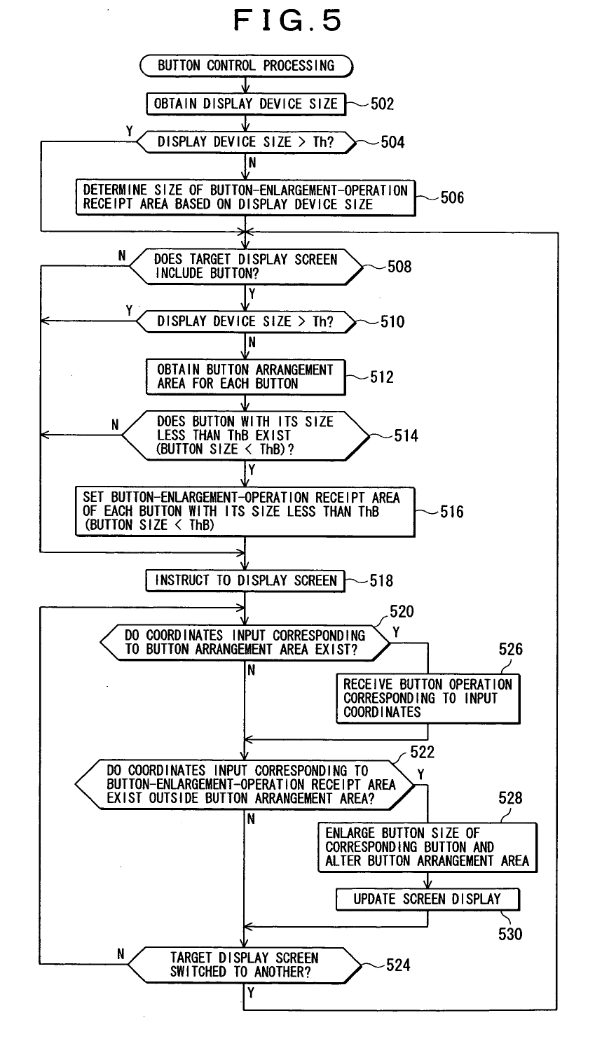

The second embodiment is obtained by modifying the button control processing of the above-mentioned first embodiment in the following manner. FIG. 5 illustrates the steps of the button control processing according to the second embodiment.

In the button control processing of the second embodiment as shown in FIG. 5, first, a size of the display screen of the display device 13 is determined as a display device size (step 502). Then, it is determined whether the display device size obtained is equal to or smaller than a preset threshold value Th or not (step 504). If it is not, the operation proceeds to step 508. If it is equal to or smaller, a size of a receipt area of a button enlargement operation on the output image before the pixel number conversion is determined in accordance with the display device size (step 506), and then the operation proceeds to step 508. The size of the button-enlargement-operation receipt area is set in such a manner that the smaller the display device size, the larger the area.

At step 508, it is determined whether or not a target display screen has a screen image including the button. Additionally, it is determined whether the display device size is larger than the above-mentioned threshold value Th or not (step 510). If the target display screen does not include the button, or if the display device size exceeds the threshold value Th, the operation proceeds to step 518. On the other hand, if the target display screen includes the button and the display device size is equal to or smaller than the threshold value Th, a button arrangement area for each button included in the target display screen is obtained based on the highlight information decoded by the PCI-HLI decoder 125 (step 512). The button arrangement area indicates the size (pixel numbers) and arrangement position of each button on the displayed output image before the pixel number conversion.

It is determined whether or not there is a button with its size (pixel numbers) smaller than the predetermined threshold value ThB on the output image before the pixel number conversion (step 514). If not, the operation proceeds to step 518. In contrast, if a button whose size on the output image before the conversion is smaller than the threshold value ThB exists, the button is regarded as a target. An area centering on the center of the target button and having the size of the button-enlargement-operation receipt area set at step 506 is set on the output image as the button-enlargement-operation receipt area for the target button (step 516).

At step 518, the presentation engine 12 provides display outputs to the display device 13 with the target display screen. After such display of the target display screen, the presence of coordinates input within the button arrangement area from the input device 15 is checked (step 520). The presence of coordinates within the button-enlargement-operation receipt area outside the button arrangement area from the input device 15 is checked (step 522). Switching the target display screen to another is checked (step 524). Note that the coordinates received from the input device 15 are converted into coordinates on the output image, in use.

If the input of coordinates occurs within the button arrangement area (step 526), a selection or determination operation of the button corresponding to the button arrangement area is received, a display format indicative of a button selection state is altered, and/or a button command defined for the button is executed (step 526), and then the operation returns to the checking step at step 520, 522, and/or 524. Note that the detection of the occurrence of the coordinate input within the button arrangement area is carried out in the same manner as the first embodiment.

If the coordinates are input within the button-enlargement-operation receipt area outside the button-arrangement area, the button display operating unit 126 enlarges the size of the button corresponding to these input coordinates within the button-enlargement-operation receipt area, at a predetermined ratio, and alters the arrangement area thereof (steps 528 and 530). This procedure is carried out by notifying the button display operating unit 126 of the enlargement ratio and the new arrangement position of the target button in the same manner as the first embodiment. The operating unit 126 modifies the subpicture and the highlight information in accordance with the notice, and then generates an output picture image including the button based on the modified subpicture and highlight information in the same manner as the first embodiment.

If the target display screen is switched to another (step 524), the operation returns to step 508.

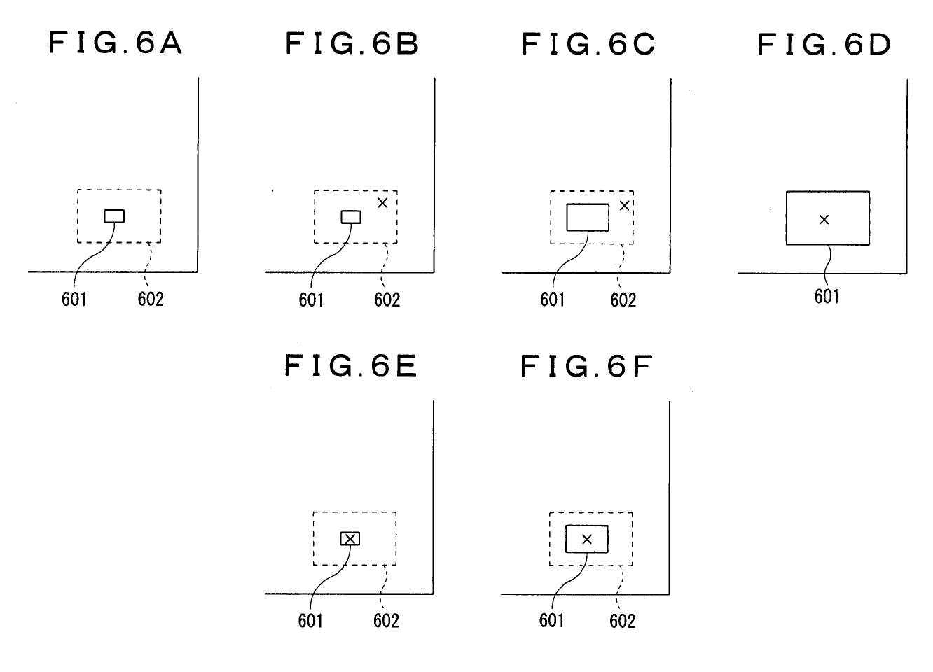

The button control processing according to the second embodiment has been explained in the above description. According to this button control processing, for example, a button-enlargement-operation receipt area 602 of a predetermined size is set so as to include a button 601 displayed in small size as shown in FIG. 6A. The smaller the display device size, the larger the button-enlargement-operation receipt area 602 is set on the output image. The actual size of the receipt area 602 on the display screen is proportional to the display screen size of the display device. Thus, the button-enlargement-operation receipt area is set in such a manner that the different receipt areas on the display screens of different display devices 13 have the same size with respect to each other regardless of the display device size.

When a user enters coordinates of a point x in the button 601, as shown in FIG. 6E, on a display screen including the button 601 shown in FIG. 6A, the operation corresponding to the button 601 is normally received. In contrast, when the user enters coordinates of a point x within the button-enlargement-operation receipt area around the button 601 as shown in FIG. 6B, the button 601 is enlarged and displayed as shown in FIG. 6C.

Then, when the user enters the point x in the button 601 on the display screen including the button 601 as shown in FIG. 6F, the operation of the button 601 is received. On the other hand, when the user enters the point x within the button-enlargement-operation receipt area around the button 601 as shown in FIG. 6C, the display of the button 601 can be further enlarged as shown in FIG. 6D. When the user enters the point x in the button 601 on the display screen including the enlarged button 601 as shown in FIG. 6D, the operation of the button is received.

As mentioned above, in the second embodiment, when the user accidentally manipulates or operates not the button, but a surrounding part thereof inaccurately because of the small size of the button, the button can be enlarged. This enables the user to easily operate the button. When the visibility of the button is not sufficient because of its small display size, the use of the above-mentioned function enlarges and displays the button by operating the surrounding part of the button, thereby permitting the user to confirm the contents of the button operation. Additionally, after such confirmation, the button can be operated or manipulated in the enlarged state and thus becomes more accessible to the users.

The second embodiment of the invention has been explained in the above description. Now, a third preferred embodiment of the invention will be described below.

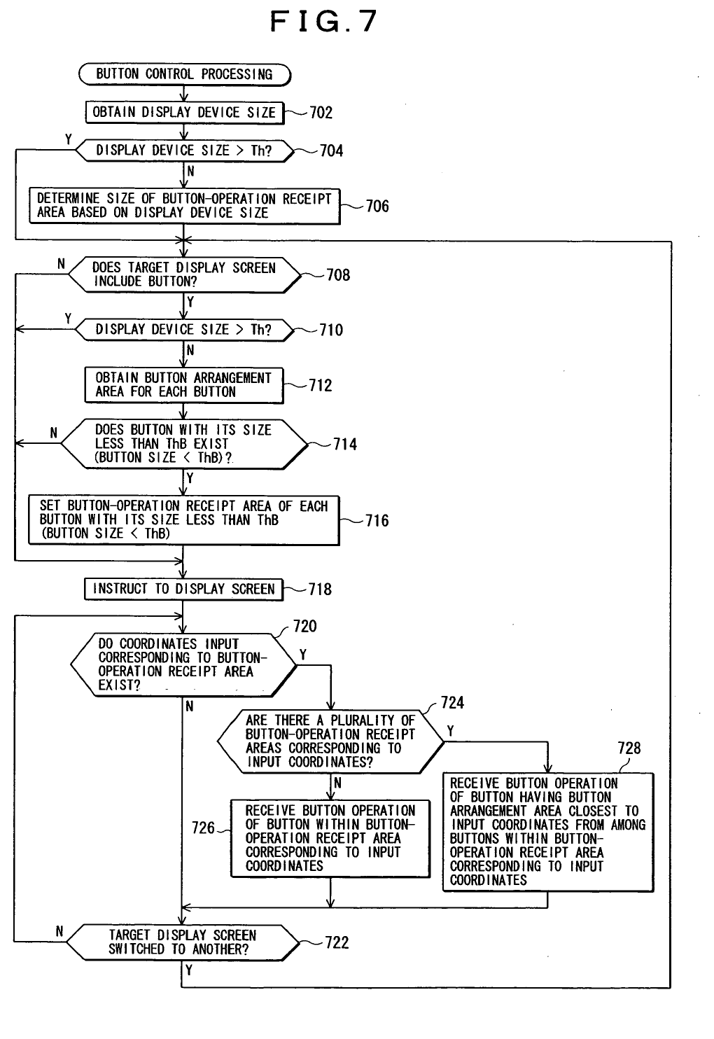

The third embodiment is obtained by modifying the button control processing of the above-mentioned first embodiment in the following manner. FIG. 7 illustrates the steps of the button control processing according to the third embodiment.

In the button control processing of the third embodiment as shown in FIG. 7, first, a size of the display screen of the display device 13 is determined as a display device size (step 702). Then, it is determined whether the obtained display device size is smaller than or equal to a preset threshold value Th or not (step 704). If it is not, the operation proceeds to step 708. If it is, a size of a receipt area of a button operation on the output image before the pixel number conversion is determined in accordance with the display device size (step 706), and then the operation proceeds to step 708. The size of the button-operation receipt area is set in such a manner that the smaller the display device size, the larger the area. Note that a ratio of the display device size to the button size may be set so that the smaller the display device size, the larger the ratio.

At step 708, it is determined whether or not the target display screen has a screen image including the button. Additionally, it is determined whether the display device size is larger than the above-mentioned threshold value Th or not (step 710). If the target display screen does not include the button, or if the display device size exceeds the threshold value Th, the operation proceeds to step 718. On the other hand, if the target display screen includes a button and the display device size is smaller than or equal to the threshold value Th, a button arrangement area of each button included in the target display screen is obtained based on the highlight information decoded by the PCI-HLI decoder 125 (step 712). The button arrangement area indicates the size (pixel numbers) and arrangement position of each button on the displayed output image before the pixel number conversion.

Then, it is determined whether or not there is a button whose size (pixel numbers) on the output image before the pixel number conversion is smaller than the predetermined threshold value ThB (step 714). If not, the operation proceeds to step 718. In contrast, if a button whose size on the output image before the conversion is smaller than the threshold value ThB exists, the button is regarded as a target. An area centering on the center of the target button and having the size of the button-operation receipt area set at step 706 is set on the output image as the button-operation receipt area for the target button (step 716), and then the operation proceeds to step 718. Note that when the ratio of the display device size to the button size is set at step 706, the button-operation receipt area in which a ratio of the display size to each target button size is adjusted to the set ratio may be set on the output image so that the center of the target button is located at the center of the area.

At step 718, the presentation engine 12 provides display outputs to the display device 13 with the target display screen. After such display of the target display screen, the presence of coordinates input within the button-operation receipt area from the input device 15 is checked (step 720). Switching the target display screen to another is also checked (step 722). Note that the coordinates input from the input device 15 are converted into coordinates on the output image.

If the input of coordinates within the button-operation receipt area (step 720) occurs, it is determined whether or not the input coordinates are included in a plurality of button-operation receipt areas (step 724). If only one receipt area includes the coordinates, a selection or determination operation of the button corresponding to the button-operation receipt area is received, a display format indicative of a button selection state is altered, and/or a button command defined for the button is executed (step 726). Subsequently, the operation returns to the checking step as denoted at the step 720 and/or step 722. In contrast, when a plurality of button-operation receipt areas include therein the input coordinates, a selection or determination operation of the button with the shortest distance from the input coordinates to its button arrangement area from among the buttons corresponding to these button-operation receipt areas is received, a display format indicative of a button selection state is altered, and/or a button command defined for the button is executed (step 726). Subsequently, the operation returns to the checking step as denoted at step 720 and/or step 722. If the target display screen is switched to another (step 722), the operation returns to step 708.

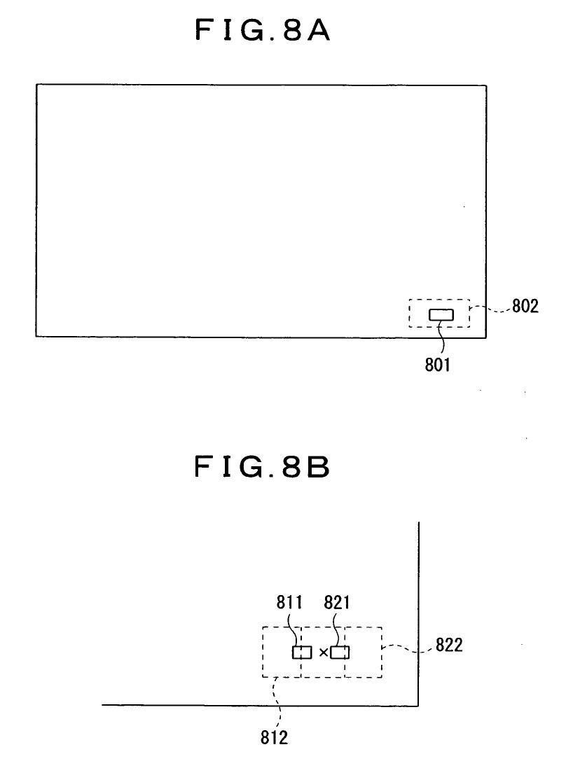

The button control processing according to the third embodiment has been explained in the above description. According to the button control processing, for example, a button-operation receipt area 802 of a size larger than that of a button 801 is set so as to include the button 801 displayed in small size as shown in FIG. 8A. The smaller the display device size, the larger the button-operation receipt area on the output image is set according to the display device size. The actual size of the receipt area on the display screen is proportional to the display device size. Accordingly, the button-operation receipt area 802 is set in such a manner that the different receipt areas on the display screens of different display devices 13 have the same size with respect to each other regardless of the display device size.

As mentioned above, providing such a button-operation receipt area 802 enables the user to execute the operation of the button 801 without precisely operating a point corresponding to the button 801, facilitating the operability of button to the user. For example, as shown in FIG. 8B, when a button-operation receipt area 812 of a button 811 overlaps a button-operation receipt area 822 of a button 821 because the buttons 811 and 821 are close to each other, if a point x within the overlap area is operated or designated, only the operation of the button 821 that is located closest to the point x designated by the user is received. Even in such a case, the user can operate the desired button with ease.

The third embodiment of the invention has been explained in the above description.

Now, a fourth preferred embodiment of the invention will be described below. The fourth embodiment is obtained by modifying the button control processing of the above-mentioned first embodiment in the following manner.

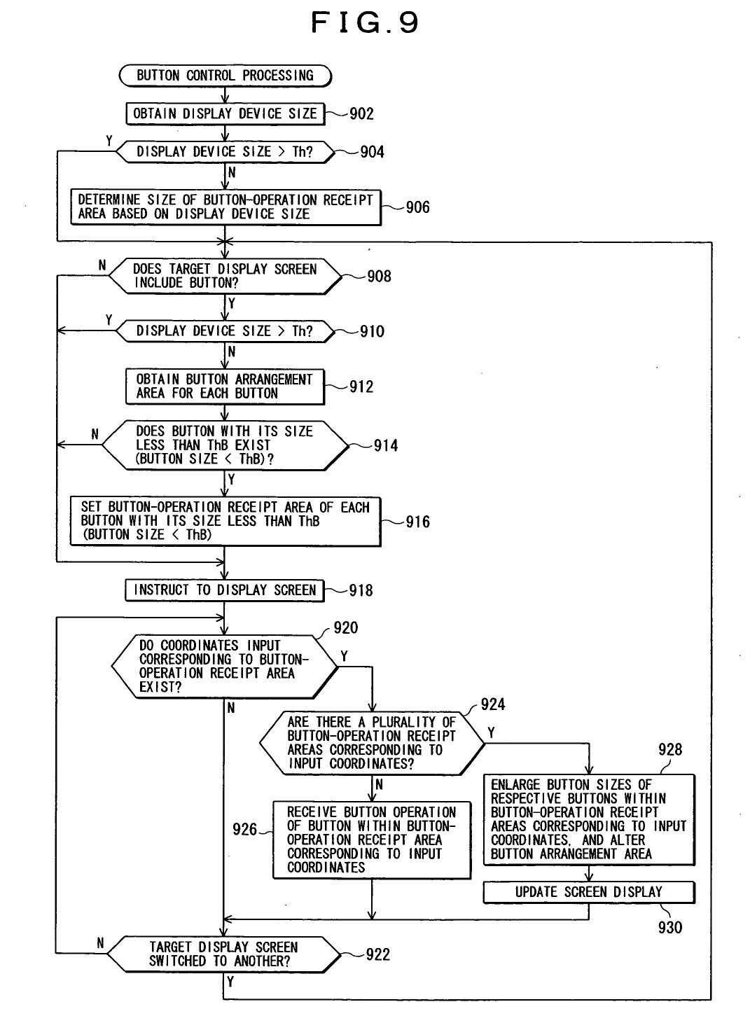

FIG. 9 illustrates the steps of the button control processing according to the fourth embodiment. As shown in FIG. 9, in the button control processing according to the fourth embodiment, first, steps 902 to 918 are carried out in the same manner as steps 702 to 718 in the button control processing according to the third embodiment.

After the display of the target display screen, the presence of coordinates input within the button-operation receipt area from the input device 15 is checked (step 920). Switching the target display screen to another also is checked (step 922). Note that the coordinates input from the input device 15 are converted into coordinates on the output image, in use.

If the input of coordinates occurs within the button-operation receipt area (step 920), it is determined whether or not the input coordinates are included in a plurality of button-operation receipt areas (step 924). If only one button-operation receipt area includes the coordinates, a selection or determination operation of the button corresponding to the button-operation receipt area is received, a display format indicative of a button selection state is altered, and/or a button command defined for the button is executed (step 926). Subsequently, the operation returns to the checking step as denoted at step 920 and/or step 922.

In contrast, when a plurality of button-operation receipt areas include therein the input coordinates, the plurality of buttons corresponding to the plural button-operation areas are set as the target buttons, and the button display operating unit 126 enlarges the size of the target buttons at a predetermined ratio and alters the arrangement areas thereof (step 928, and step 930). This processing is carried out by notifying the button display operating unit 126 of the enlargement ratio and the new arrangement positions of the target buttons in the same manner as the first embodiment. The button display operating unit 126 modifies the subpicture and the highlight information in the same way as the first embodiment, and creates the output picture image including the buttons in accordance with the modified subpicture and highlight information. Subsequently, the operation returns to the checking step as denoted at step 920 and/or step 922. If the target display screen is switched to another (step 922), the operation returns to step 908.

The button control processing according to the fourth embodiment has been explained in the above description. According to this button control processing, for example, a button-operation receipt area 802 of a size larger than that of a button 801 is set so as to include the button 801 displayed in small size as shown in FIG. 8A as is the case with the third embodiment. Therefore, this permits the user to operate the button 801 without precisely operating or designating a point corresponding to the button 801, thereby facilitating the operability of the button to the user.

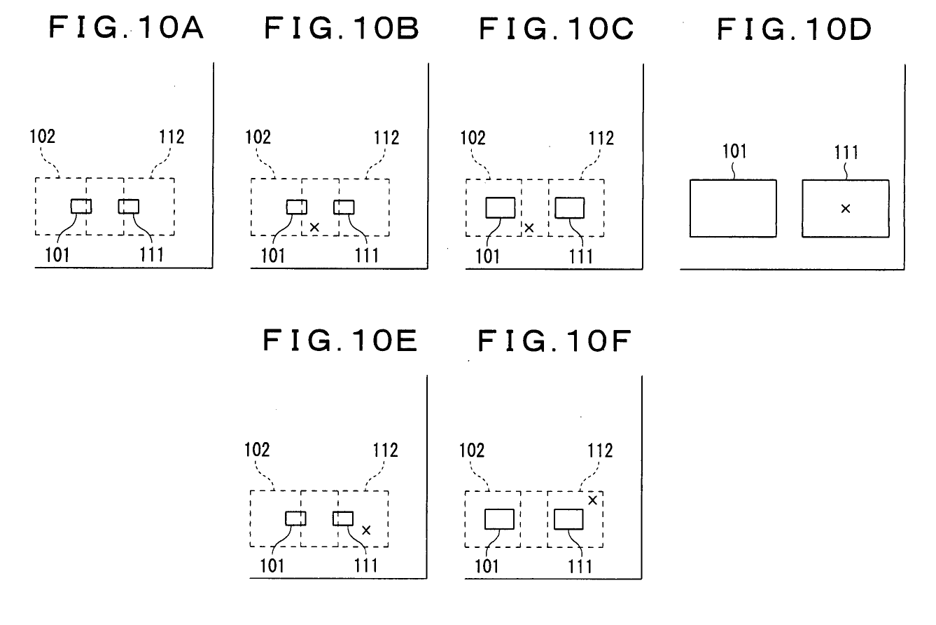

For example, when a button-operation receipt area 102 of a button 101 overlaps a button-operation receipt area 112 of a button 111 because the buttons 101 and 111 are close to each other as shown in FIG. 10A, if a point x within only one of the button-operation receipt areas 112 is entered by the user, the operation of the button 102 corresponding to this button-operation receipt area 112 is received as shown in FIG. 10E. On the other hand, when the point x within the overlap area is entered as shown in FIG. 10B, both buttons 101 and 111 are enlarged and displayed as shown in FIG. 10C. Then, on the display screen including the buttons 101 and 111 enlarged in a manner shown in FIG. 10C, the point x included in only one of the button-operation receipt areas 112 is entered by the user, so that the operation of the button 102 corresponding to this button-operation receipt area 112 is received as shown in FIG. 10F.

In contrast, when the point x is entered again within the overlap area of the button-operation receipt area 102 and the button-operation receipt area 112 as shown in FIG. 10C, both of the buttons 101 and 111 are further enlarged as shown in FIG. 10D. Thereafter, on the display screen including the enlarged buttons 101 and 111 as shown in FIG. 10D, when the user enters the point x within the button 111 or button-operation receipt area 112, the corresponding operation of the button 111 is received.

This button control processing permits the user to operate the button without precisely manipulating the spot corresponding to the button, thereby facilitating the user's button operation. For example, when the button-operation receipt area 102 of the button 101 overlaps the button-operation receipt area 1 12 of the button 111 because the buttons 101 and 111 are close to each other as shown in FIG. 10A, if the point x within the overlap area is entered by the user, both buttons 101 and 111 are enlarged to facilitate the operation thereof, whereby, even in this case, the user can surely execute the operation of the desired button with ease.

It should be noted that although the application of the DVD video reproduction apparatus is taken as an example in the above embodiments, the technique for facilitating the button operation shown in FIGS. 4, 6, 8 and 10 may be applied in the same way to any devices employing a user interface that displays a button for receipt of an operation on the display device 13. For example, the technique for improving the button operability may be employed in a general-purpose computer. To improve the operability of a display object other than a button, the technique may be applied in the same manner.

The embodiments described above are merely examples of the present invention. The technical scope of the present invention should not be understood to be limited by the embodiments described above. Various changes and modifications can be made to the present invention without departing from the spirit and scope thereof.

1. A button processing method for displaying a button on a display device in accordance with a button area definition for specifying size and arrangement of the button in an image space, and receiving an operation corresponding to the displayed button via an input device, the method comprising:
when the size of a display screen of the display device is smaller than a predetermined screen size, setting an enlargement ratio of a button in such a manner that the smaller the display screen size, the larger the ratio; and
enlarging a button whose display size on the display device is smaller than a predetermined size at said button enlargement ratio to display the enlarged button on the display device, the display size of the button being defined according to the display screen size and the size of the button in the image space specified by at least the button area definition.

2. A button processing method for displaying a button on a display device in accordance with a button area definition for specifying size and arrangement of the button in an image space, and receiving an operation corresponding to the displayed button via an input device, the method comprising:
when the size of a display screen of the display device is smaller than a predetermined screen size, setting a receipt area of the button operation centered on the button in such a manner that the smaller the display screen size of the display device, the larger the size of the button-operation receipt area in an image space, for a button whose display size on the display device is smaller than a predetermined size, the display size of the button on the display device being defined according to the display screen size and the size of the button in the image space specified by at least the button area definition; and
receiving the operation of a button whose button-operation receipt area has been set, in accordance with a position operation of a point via the input device within an area on the display screen corresponding to the button-operation receipt area.

3. A button processing method for displaying a button and receiving an operation corresponding to the displayed button via an input device, comprising:
setting a receipt area of a button-enlargement-operation around a button whose display size on a display device is smaller than a predetermined size; and
enlarging a button whose button-enlargement-operation receipt area has been set to display an enlarged button on the display device in accordance with a position operation of a point within said button-enlargement-operation receipt area via the input device.

4. A button processing method for displaying a button and receiving an operation corresponding to the displayed button via an input device, comprising:
setting a receipt area of a button operation including the button and surroundings thereof, for a button whose display size on a display device is smaller than a predetermined size;
if a position operation of a point is performed within said button-operation receipt area via the input device when a single button-operation receipt area including the operated point exists, receiving the operation of the button whose button-operation receipt area has been set; and
if the position operation of the point is performed within a plurality of button-operation receipt areas via the input device, receiving the operation of the button having the shortest distance to the operated point among the plurality of buttons whose button-operation receipt areas include the operated point.

5. A button processing method for displaying a button and receiving an operation corresponding to the displayed button via an input device, comprising:
setting a receipt area of a button operation including the button and surroundings thereof, for a button whose display size on a display device is smaller than a predetermined size;
if a position operation of a point is performed within the button-operation receipt area via the input device when a single button-operation receipt area including the operated point exists, receiving the operation of the button whose button-operation receipt area has been set; and
if the position operation of the point is performed within a plurality of button-operation receipt areas via the input device, enlarging the plurality of buttons whose button-operation receipt areas include the operated point to display the enlarged buttons on the display device.

6. A data processing apparatus for displaying a button on a display device in accordance with a button area definition for specifying size and arrangement of the button in an image space, and for receiving an operation corresponding to the displayed button via an input device to execute processing corresponding to the button whose operation is received, the apparatus comprising:
a button enlargement ratio setting unit that, when a size of a display screen of the display device is smaller than a predetermined screen size, sets an enlargement ratio of a button in such a manner that the smaller the display screen size, the larger the ratio; and
a button enlargement display processor for enlarging a button whose display size on the display device is smaller than a predetermined size at said button enlargement ratio to display the enlarged button on the display device, the display size of the button being defined according to the display screen size and the size of the button in the image space specified by at least the button area definition.

7. The data processing apparatus according to claim 6, wherein said data processing apparatus is adapted to display a button in accordance with the button area definition recorded in a DVD-Video disc as highlight information, and to reproduce video presentation data recorded in the DVD-Video disc in accordance with the user's operation of the button.

8. A data processing apparatus for displaying a button on a display device in accordance with a button area definition for specifying size and arrangement of the button in an image space, and for receiving an operation corresponding to the displayed button via an input device to execute processing corresponding to the button whose operation is received, the apparatus comprising:
a button-operation receipt area setting unit that, when the size of a display screen of the display device is smaller than a predetermined screen size, sets a receipt area of the button operation centered on the button in such a manner that the smaller the display screen size of the display device, the larger the size of the button-operation receipt area in an image space, for a button whose display size on the display device is smaller than a predetermined size, the display size of the button on the display device being defined according to the display screen size and the size of the button in the image space specified by at least the button area definition; and
a button-operation receipt unit for receiving the operation of a button whose button-operation receipt area has been set, in accordance with a position operation of a point via the input device within an area on the display screen corresponding to the button-operation receipt area.

9. The data processing apparatus according to claim 8, wherein said data processing apparatus is adapted to display a button in accordance with the button area definition recorded in a DVD-Video disc as highlight information, and to reproduce video presentation data recorded in the DVD-Video disc in accordance with the user's operation of the button.

10. A data processing apparatus for displaying a button, and for receiving an operation corresponding to the displayed button via an input device to execute processing corresponding to the button whose operation is received, the apparatus comprising:
a button-enlargement-operation receipt area setting unit for setting a receipt area of a button enlargement operation around a button whose display size on a display device is smaller than a predetermined size; and
a button enlargement display processor for enlarging a button whose button-enlargement-operation receipt area has been set to display an enlarged button on the display device in accordance with a position operation of a point within said button-enlargement-operation receipt area via the input device.

11. The data processing apparatus according to claim 10, wherein said data processing apparatus is adapted to display a button in accordance with a button definition recorded in a DVD-Video disc, and to reproduce video presentation data recorded in the DVD-Video disc in accordance with the user's operation of the button.

12. A data processing apparatus for displaying a button, and for receiving an operation corresponding to the displayed button via an input device to execute processing corresponding to the button whose operation is received, the apparatus comprising:
a button-operation receipt area setting unit for setting a receipt area of a button operation which includes the button and surroundings thereof, for a button whose display size on a display device is smaller than a predetermined size; and
a button-operation receipt unit which, if a position operation of a point is performed within said button-operation receipt area via the input device, receives the operation of the button whose button-operation receipt area has been set when a single button-operation receipt area including the operated point exists, and which receives the operation of the button having the shortest distance to the operated point among a plurality of buttons whose button-operation receipt areas have been set when a plurality of corresponding button-operation receipt areas including the operated point exist.

13. The data processing apparatus according to claim 12, wherein said data processing apparatus is adapted to display a button in accordance with a button definition recorded in a DVD-Video disc, and to reproduce video presentation data recorded in the DVD-Video disc in accordance with the user's operation of the button.

14. A data processing apparatus for displaying a button, and for receiving an operation corresponding to the displayed button via an input device to execute processing corresponding to the button whose operation is received, the apparatus comprising:
a button-operation receipt area setting unit for setting a receipt area of a button operation which includes the button and surroundings thereof, for a button whose display size on a display device is smaller than a predetermined size; and
a button-operation receipt unit that, if a position operation of a point is performed within said button-operation receipt area via the input device, receives the operation of the button whose button-operation receipt area has been set when a single button-operation receipt area including the operated point exists; and
a button-enlargement display processor that, if the position operation of the point is performed within a plurality of button-operation receipt areas via the input device, enlarges the buttons corresponding to the plurality of button-operation receipt areas to display the enlarged buttons on the display device.

15. The data processing apparatus according to claim 14, wherein said data processing apparatus is adapted to display a button in accordance with a button definition recorded in a DVD-Video disc, and to reproduce video presentation data recorded in the DVD-Video disc in accordance with the user's operation of the button.
